(19) United States
(12) Patent Application Publication
(10) Pub. No.: US 2012/0060660 A1
(43) Pub. Date: Mar. 15, 2012

(54) Method for Operating a Processing Roller

(75) Inventors: Sven Erler, Muelsen (DE); Thomas Illig, Tamm (DE); Stephan Schultze, Lohr-Wombach (DE)

(73) Assignee: Robert Bosch GmbH, Stuttgart (DE)

(21) Appl. No.: 13/257,308

(22) PCT Filed: Feb. 10, 2010
(86) PCT No.: PCT/EP2010/000816

§ 371 Date: Nov. 29, 2011

(30) Foreign Application Priority Data
Mar. 18, 2009 (DE) 10 2009 013 850.1

(51) Int. Cl. B26D 1/00

(52) U.S. Cl. 83/13

(57) ABSTRACT

A method for operating a processing roller of a processing machine having a circumferential length and comprising a tool having a tool length extending in the circumferential direction is disclosed. A processing length extending in the circumferential direction is defined, along which the tool is engaged with the material to be processed during processing. A compensation length in the circumferential direction is further prescribed, along which a compensation motion of the processing roller is performed, wherein the tangential velocity of the processing roller is negative at least at times. The compensation length is determined using the circumferential length, the processing length, and the tool length.

The present invention relates to a method for operating a processing roller, a computing unit, a corresponding computer program and a corresponding computer program product.

### PRIOR ART

Transverse processing applications, i.e. applications in which, for example, a material web is severed in a rotary manner by means of a transverse cutter, are well known. Further examples of transverse processing applications or corresponding transverse processing arrangements are transverse sealing arrangements, transverse perforating arrangements and transverse punching arrangements. A section length which is processed, for example severed, in this case is not necessarily identical to the circumference of the transverse processing roller that is used. By selecting suitable laws of motion for the transverse processing roller, it is possible for a typically material-web synchronous cut to be carried out during processing and for what is known as a compensating movement to be carried out the rest of the time. This compensating movement serves to achieve a relatively short or relatively long format (section length) as what is known as the synchronous length, which corresponds to the circumference of the transverse processing roller.

A method for operating a transverse processing roller is described in DE 10 2007 034 834 A1. An energy-saving compensating movement can accordingly be achieved when the compensating length, i.e. that part of the circumferential length of the transverse processing roller which can be used for the compensating movement, is determined on the basis of a synchronous region (region of synchronous tangential speed of the roller and advancing speed of the material). The compensating movement, comprising the braking, turning backward and accelerating of the roller, can thus be carried out within the greatest possible limits. The synchronous region in the case of transverse cutters is defined such that the cut takes place precisely in the middle of the region. Enlarging the synchronous region on both sides ensures that the blade dips into and out of the material cleanly. If, in the case of the transverse cutter, oscillating is allowed up to the edge of the synchronous region, it is ensured that the blade does not dip into material passing underneath the transverse cutter during the oscillating process.

However, this consideration cannot be transferred in principle to longitudinal cutting operations, since in this case the cutting length or the synchronous region cannot correspond in every case to the tool length and thus a backward turn as far as the edge of the cutting length or of the synchronous region can possibly even lead to movement of the tool into the material. In the case of longitudinal cutters or slotters, the length of the slot to be created initially defines the synchronous region. This length does not absolutely have to correspond to the length of the blade employed. Enlarging the synchronous region on one side can ensure that the blade dips into and out of the material cleanly. Since slotters are operated with separate sheets which are at a defined spacing from one another, it is possible with just one blade to cut slots having a length which is shorter as desired than the length of the blade, if the unused part of the blade passes the bottom dead center of the slotter before or after the edge of the sheet. Compensating movements comprising a controlled backward turn of the processing roller are not known for longitudinal cutters in the prior art.

It is therefore desirable to specify a, for example energy-optimized, compensating movement in particular for longitudinal processing rollers.

Proceeding from this prior art, the present invention proposes a method, a computing unit, a computer program and a computer program product having the features of the independent patent claims. Advantageous configurations are the subject matter of the dependent claims and of the following description.

In the case of a method according to the invention for operating a processing roller of a processing machine, said processing roller having a circumferential length and a tool with a length that extends in the circumferential direction, a processing length or cutting length which extends in the circumferential direction is defined, and during processing the tool is in engagement along said processing length with the material to be processed. Furthermore, a compensating length or oscillating length in the circumferential direction is predefined, and a compensating movement of the processing roller is or can be carried out along said compensating length, wherein the tangential speed of the processing roller is negative at least some of the time. According to the invention, the compensating length is determined on the basis of the circumferential length, the processing length and the tool length. The compensating length describes at least the length which is available or is used for a backward movement. Depending on the configuration, the accelerating and/or braking process also can use the compensating length. However, it is likewise possible for the accelerating and/or braking length to differ from the compensating length.

It is expedient for the above-cited lengths to have a common relationship. This may be formed for example by the circumference of the roller or the rolling length on the material.

### ADVANTAGES OF THE INVENTION

The invention teaches in particular also to take into account the tool length when determining the compensating length. In the solutions known in the prior art for transverse cutters, however, only the cutting length or the synchronous region (region of synchronous tangential speed of the roller and advancing speed of the material) is taken into account. By means of the solution according to the invention, in particular also an energy-optimized compensating movement including a controlled backward turn can now be provided for longitudinal processing rollers. Although in the present description primarily longitudinal processing rollers, such as longitudinal cutters, for example, are mentioned, the invention is suitable for all kinds of processing rollers, in which the cutting length is not the same as the tool length, i.e. a part of the tool has already passed the bottom dead center, without coming into contact with material. The invention affords the possibility of carrying out energy-optimized movements and thus to use lower-powered drives, inverters, etc., which are thus more cost-effective to procure and to maintain.

Advantageously, the compensating length is determined on the basis of a synchronous region that includes the processing length. In order to ensure that the tool dips cleanly into and out of the material, the synchronous region, i.e. the region of synchronous tangential speed of the roller and advancing speed of the material, can be enlarged beyond the processing length. Since the synchronous region, but not necessarily the processing length, is known within the machine control means, the method can be implemented easily in this way.

Preferably, the compensating length is determined as the difference between the circumferential length and the sum of the tool length and a portion of the processing length or of the synchronous region that is not located within the tool length. With this embodiment, the maximum available length can be used for the compensating movement, thereby providing a particularly energy-saving solution. The backward movement can thus take place (in the borderline case) exactly as far as the tool. This allows maximum stopping and accelerating paths, which leads to a considerable reduction in the maximum accelerations that occur.

In another configuration, the compensating length is determined as the difference between the circumferential length and the sum of the processing length or the synchronous region and twice a portion of the tool length that is not located within the processing length or the synchronous region. In this case, the processing length or the synchronous region is extended in both directions by the excess tool length. Although this incurs unnecessary loss of energy, since the compensating length is not allocated to all the available space, this embodiment is in practice easy to implement, since the mid-point of the synchronous region does not move. In particular, the methods already used for transverse cutters from the applicant can thus be transferred relatively easily.

Preferably, the processing roller can implement any desired compensating laws of motion. These can be selected such that there is as little energy consumption as possible. The energy consumption can in this case be determined or estimated for example on the basis of the square of the acceleration of the drive and/or of the roller. Therefore, it is possible to minimize lost energy, as a result of which the energy costs are minimized.

The different laws of motion can also be optimized according to various criteria. Criteria to be mentioned are for example the energy consumption of the compensating movement, which, for example when describing the movement of the roller by means of a polynomial of the 3rd degree, is particularly small. Polynomials of the 3rd degree or sinoids prove to be advantageous for optimization, too.

It is likewise possible to optimize the laws of motion with regard to protecting the mechanism, in particular of the drive and/or roller, in particular the gearwheels used. To this end, modified sinusoidal lines, for example Bestehorn sinusoidal lines having low jolt characteristic values, can be used. It is for example also possible to select the laws of motion with regard to minimizing the maximum accelerations that occur. Polynomials of the 2nd degree can be used for this purpose.

By means of these measures, the laws of motion that can be used can be selected for example in an energy-optimized manner, with account being taken here in particular of heating, energy consumption and the size of the motor or amplifier. The laws of motion used can be optimized to the maximum moment, for example the maximum speed advancement or the size of the drive or motor or amplifier. The law of motion selected can likewise be optimized to protect the mechanism, as a result of which it is possible, for example, for less noise to be generated.

In a preferred embodiment, the compensating length is additionally determined on the basis of a material length. In contrast to transverse cutters, with which typically material webs are cut to length to form sheets, the material fed to the longitudinal cutter or slotter is usually already present in separate sheets. The configuration of the machine typically provides for the front edge of each sheet to reach the bottom dead center of the slotter at a defined master shaft position (e.g. 0°). Sheets can be larger than the developed length of the master shaft, which corresponds typically to the circumference of the heaviest and most undynamic machine component—e.g. impression cylinder, rotary-die cutter, etc. This means that a new sheet does not in principle begin with each cycle of the master shaft. It is possible, from the predetermined values “master shaft position at which the sheet reaches the slotter”, “developed length of the master shaft” and “material length”, to determine in which region of the master shaft position there is no material in the engagement region of the slotter. This information can be used in calculating the compensating movement so that, in the regions in which there is no material in the engagement region of the slotter, the compensating length can reach as far as into the synchronous region of the cut and beyond. On account of lower acceleration and deceleration values, this is more dynamically and energetically efficient than oscillating as far as at most the start of the processing length or of the synchronous region.

A computing unit according to the invention is set up, in particular in terms of its programming, to carry out a method according to the invention.

The invention also relates to a computer program having program code means in order to carry out all of the steps of a method according to the invention when the computer program is executed on a computer or a corresponding computing unit.

The computer program product which is provided according to the invention and has program code means which are stored on a computer-readable data carrier is designed to carry out all of the steps according to a method according to the invention, when the computer program is executed on a computer or a corresponding computing unit. Suitable data carriers are in particular floppy disks, hard disks, flash memories, EEPROMs, CD-ROMs, DVDs, and the like. It is also possible to download a program via computer networks (Internet, intranet, etc.).

Further advantages and configurations of the invention can be gathered from the description and the accompanying drawing.

It goes without saying that the features mentioned above and those still to be explained hereinbelow can be used not only in the combination given in each case but also in other combinations or in their own right, without departing from the scope of the present invention.

The invention is illustrated schematically in the drawing on the basis of exemplary embodiments and is described in detail in the following text with reference to the drawing.

### DESCRIPTION OF THE FIGURES

FIG. 1 shows a schematic illustration of a processing device in which the invention can advantageously be used,

FIG. 2 schematically shows the length definitions which are possible in a processing device according to FIG. 1, and

FIG. 3 shows contour curves of a movement sequence of a preferred longitudinal cutter application.

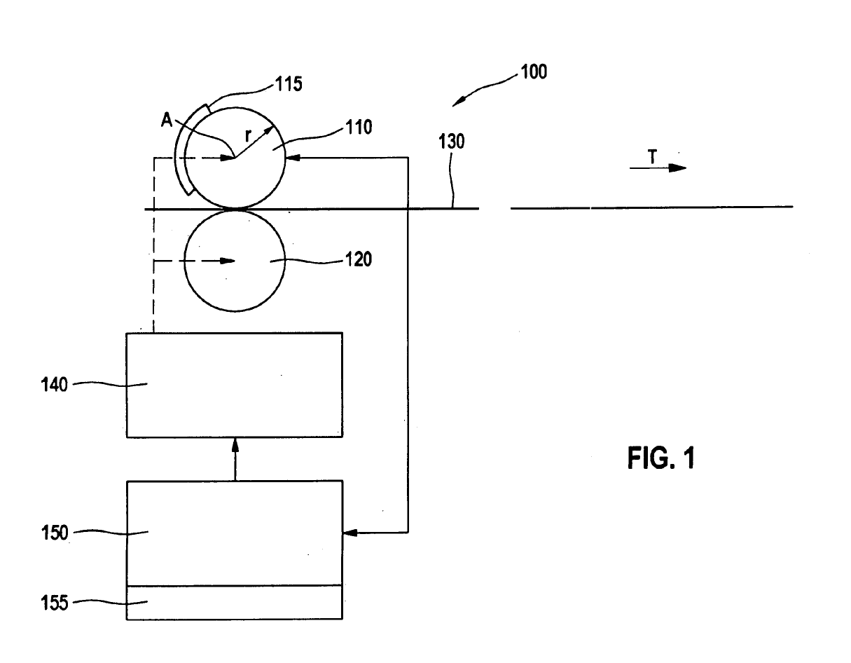

FIG. 1 schematically illustrates a processing device, which is designed here as a longitudinal cutter device and has the overall designation 100. The longitudinal cutter device has a longitudinal processing roller 110 and a counterpressure roller 120 that interacts with said longitudinal processing roller 110. The longitudinal processing roller 110 and optionally also the counterpressure roller 120 can be driven by means of a drive 140.

The drive is controlled by means of a control device 150, which comprises in particular an operator interface 155.

Between the longitudinal processing roller 110 and the counterpressure roller 120, material 130 is transported, in particular separately (for example in the form of sheets), in the transporting direction T.

The material 130 is severed in the longitudinal direction by means of a cutting device 115, which is provided on the longitudinal processing roller 110 and is in particular in the form of a cutting blade.

Depending on the desired shape of the cut, outside the synchronous region a relatively quick or slow movement of the longitudinal processing roller 110, i.e. a relatively quick or slow rotation about its rotational axis A, in relation to the transporting speed of the material 130 takes place in the transporting direction T. These movement sequences are controlled by means of the control device 150, with appropriate control commands being sent to the drive 140. Control commands can be introduced into the control device in particular via the interface 155. Furthermore, by inputting appropriate format specifications by means of the interface, an automatic selection or calculation of the laws of motion is possible by means of the control device 150.

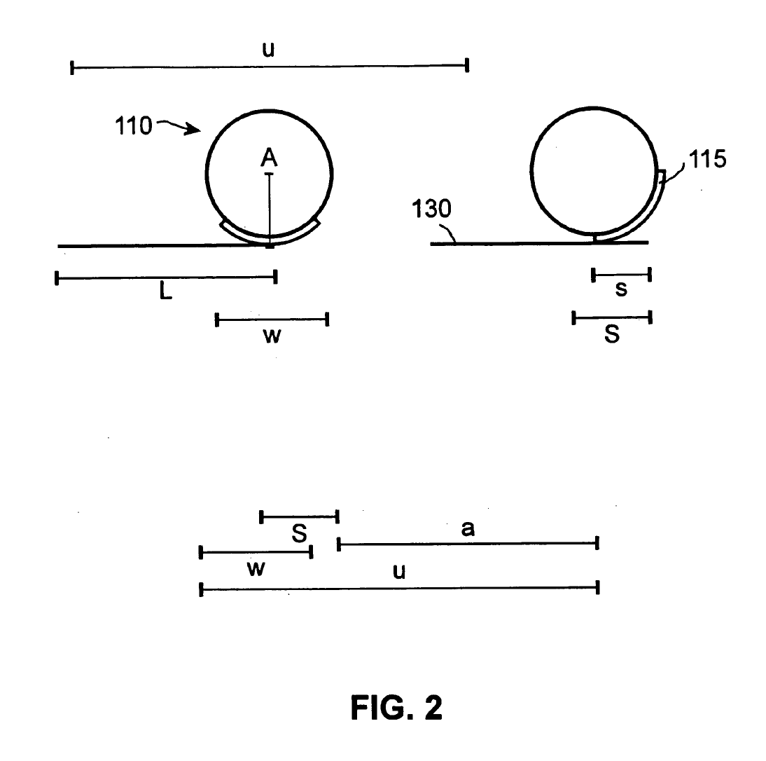

With reference to FIG. 2, a longitudinal processing roller 110 having a cutting device or a blade 115 is used in order to process separated material 130, such as sheets of cardboard, for example. The individual lengths to be explained hereinbelow are referred to the processing point, i.e. the outer circumference of the cutting device 115 or the material transporting plane.

The processing roller 115 has a circumferential length u, which is defined by the distance of the rotational axis A of the longitudinal processing roller 110 from the material 130 to be processed (u=2rp). The material 130 has a length L and the cutting device 115 has a tool length w.

Illustrated on the left-hand side in FIG. 2 is the start of the processing operation, i.e. the time at which a sheet of material 130 reaches the engagement region of the processing roller 110 and at the same time the processing roller 110 is positioned such that the cutting device 115 is likewise in the engagement region. In order to achieve clean processing, a synchronous movement of the longitudinal processing roller 110 and of the material 130 is necessary at the latest at this time.

Shown on the right-hand side in FIG. 2 is a second time, at which the processing operation ends. Although the material 130 is still in the engagement region of the longitudinal processing roller 110, the cutting device 115 is on the point of leaving it. The processing length or cutting length achieved by the processing is designated s. However, in order to execute the processing with high quality, a synchronous region or a synchronous length S is defined, said synchronous region or synchronous length S extending beyond the cutting length on one or both sides and describing the region of synchronous movement of the longitudinal processing roller 110 and the material 130.

Once the synchronous region S has left the point of engagement or the bottom dead center, a compensating movement is carried out. Depending on the length L and speed of the material 130 and the position of the next processing operation (e.g. the end of the same sheet of material or the start of the next sheet of material), this compensating movement comprises an acceleration or braking, optionally to a standstill, of the processing roller 110. In the case of braking to a standstill and a subsequent acceleration, which takes place before the next processing, it is appropriate, for optimum energy saving, to assign all the available space to the compensating length.

In the prior art, the synchronous region S is to this end subtracted from the circumferential length u and the resulting residual length is defined as the compensating length. However, this cannot be transferred to the situation according to FIG. 2, since the cutting device 115 protrudes at least on one side beyond the synchronous region S. For this reason, according to the invention the compensating length is additionally determined taking the tool length w into account. As is shown at the bottom of FIG. 2, the compensating length is determined, according to the preferred embodiment illustrated, as the difference between the circumferential length u, the tool length w and that portion of the synchronous region that extends beyond the tool. In this embodiment, the largest possible portion is available for the compensating length a.

It goes without saying that these considerations can also be applied in the case of a processing roller which has more than one tool.

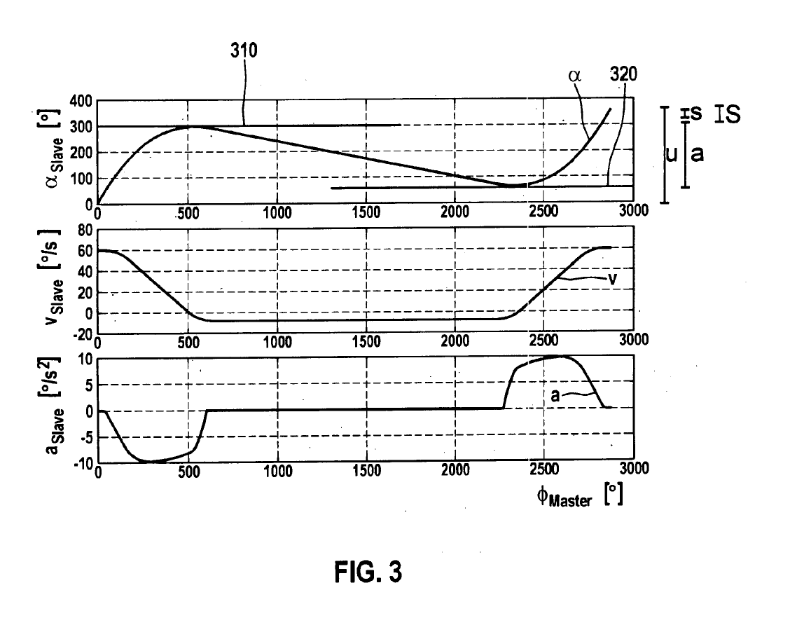

FIG. 3 illustrates a movement sequence of a processing device, for example a longitudinal processing roller, according to a preferred embodiment of the invention. Individual graphs with regard to a processing and compensating movement of a longitudinal processing roller are illustrated. In this case, individual graphs are illustrated for the (angular) position of the roller (a), its speed (v) and its acceleration (a). In the present case, the speed v is important. A cutting region, i.e. the region in which the material web is cut by means of the cutting blade 115, is designated s and the synchronous region is designated S.

Illustrated on the x axis is the machine angle F_{Master} (=the master shaft position), a revolution of the master shaft is plotted for example over 2875° (increments). Illustrated on the y axis is the movement of the processing shaft. Illustrated at the top is the machine angle a_{Slave}, a revolution is in this case assumed for example to be 360°.

While the synchronous region is in the engagement region of the roller, the tangential speed v_{Slave} of the processing roller is identical to the positive advancement speed of the material to be processed, in the example shown approx. 60°/s multiplied by distance or radius. The position a_{Slave} and the acceleration a_{Slave} of the transverse processing roller result directly from the selected speed.

There can be seen two boundary lines 310, 320, by means of which the compensating length a is illustrated, i.e. that the braking, the backward movement and the acceleration of the processing roller take place here.

The illustration shown is based on an arrangement of the cutting device on the processing roller in the region of from 310° to 60°. Cutting or processing is carried out at the end of a separated material, this being apparent from the relative position of the cutting region s and the tool length (310°-60°). In order to achieve clean processing, the cutting length s is extended by 10° on both sides, in order to form the synchronous region S. The end of the cutting length s at 350° is defined in that the material leaves the engagement region of the processing roller. At this time, the braking process could already have been started, in order to provide processing which is as energy efficient as possible. However, in order to simplify actuation, in the present example, a symmetrical configuration is selected, i.e. the path lengths for the braking process, the backward movement and also the accelerating process are equal to the compensating length a. According to a likewise preferred configuration (not illustrated) of the invention, an asymmetrical movement can be selected, i.e. in the present example, the braking length would be longer than the accelerating length and the length available for the backward movement (=compensating length). The last two would correspond to the compensating length (only the rear edge in the processing illustrated here; when processing the front and rear edges, the accelerating length could also turn out to be longer than the compensating length).

With the method according to the invention and on account of specific requirements of a user, for example with regard to desired processing distances, permissible turning backward of the processing roller, etc., it is possible in a flexible manner to calculate the optimum compensating movement for the respective requirements on the basis of different laws of motion. On the basis of the geometric and physical parameters (lengths, distances, speeds, etc.), the system calculates the optimum compensating movement on the basis of a large number of possible laws of motion. The turning backward of the compensating movement can be predetermined and/or limited.

In different machine configurations, the tangential speed can range from positive throughout to negative at least some of the time. Alternatively or in addition, a negative tangential speed of the processing roller can merely be permitted; in this case, the tangential speed does not necessarily have to be negative at least some of the time in every operating state.

It goes without saying that only exemplary embodiments of the invention are illustrated in the figures. In addition, any other embodiment is conceivable without departing from the scope of this invention.

1. A method for operating a processing roller of a processing machine, said processing roller having a circumferential length and a tool with a length that extends in the circumferential direction,
wherein a processing length which extends in the circumferential direction is defined, and during processing the tool is in engagement along said processing length with the material to be processed,
wherein a compensating length in the circumferential direction is predefined, and a compensating movement of the processing roller is carried out along said compensating length, wherein the tangential speed of the processing roller is negative at least some of the time, and
wherein the compensating length is determined on the basis of the circumferential length, the processing length and the tool length.

2. The method as claimed in claim 1, wherein the compensating length is determined on the basis of a synchronous region that includes the processing length.

3. The method as claimed in claim 1, wherein the compensating length is determined as the difference between the circumferential length and the sum of the tool length and a portion of the processing length or of the synchronous region that is not located within the tool length.

4. The method as claimed in claim 1, wherein the compensating length is determined as the difference between the circumferential length and the sum of the processing length or the synchronous region and twice a portion of the tool length that is not located within the processing length or the synchronous region.

5. The method as claimed in claim 1, in which the processing roller is in the form of a longitudinal cutting roller.

6. The method as claimed in claim 1, in which the compensating movement is selected such that there is as little energy consumption as possible.

7. The method as claimed in claim 1, in which the compensating length is additionally determined on the basis of a material length.

8. The method as claimed in claim 1, wherein the compensating movement comprises only a backward movement.

9. A computing unit which is configured to carry out a method for operating a processing roller of a processing machine, said processing roller having a circumferential length and a tool with a length that extends in the circumferential direction,
wherein a processing length which extends in the circumferential direction is defined, and during processing the tool is in engagement along said processing length with the material to be processed,
wherein a compensating length in the circumferential direction is predefined, and a compensating movement of the processing roller is carried out along said compensating length, wherein the tangential speed of the processing roller is negative at least some of the time, and
wherein the compensating length is determined on the basis of the circumferential length, the processing length and the tool length.

10. (canceled)

11. A computer program product having program code means which are stored on a computer-readable data carrier, in order to carry out all of the steps of a method when the computer program is executed on a computer or a corresponding computing unit, said method being for operating a processing roller of a processing machine, said processing roller having a circumferential length and a tool with a length that extends in the circumferential direction,
wherein a processing length which extends in the circumferential direction is defined, and during processing the tool is in engagement along said processing length with the material to be processed,
wherein a compensating length in the circumferential direction is predefined, and a compensating movement of the processing roller is carried out along said compensating length, wherein the tangential speed of the processing roller is negative at least some of the time, and
wherein the compensating length is determined on the basis of the circumferential length, the processing length and the tool length.
